(19) United States
(12) Patent Application Publication
(10) Pub. No.: US 2026/0303487 A1
(43) Pub. Date: Oct. 1, 2026

(54) EXPANSION BOARD, DATA COLLECTION SYSTEM, DATA COLLECTION METHOD, AND RECORDING MEDIUM

(71) Applicant: Mitsubishi Electric Corporation, Tokyo (JP)

(72) Inventors: Takeshi SAITO, Tokyo (JP); Yu KATAOKA, Tokyo (JP)

(73) Assignee: Mitsubishi Electric Corporation, Tokyo (JP)

(21) Appl. No.: 19/478,850

(22) PCT Filed: Nov. 16, 2023
(86) PCT No.: PCT/JP2023/041232

§ 371 Date: Oct. 27, 2025

(51) Int. Cl. H04L 43/02

(52) U.S. Cl. CPC H04L 43/02

(57) ABSTRACT

An expansion board includes a first communication interface, a second communication interface, a third communication interface, and a controller. The first communication interface is connectable to a first terminal to allow communication with the connected first terminal. The second communication interface is connectable to a second terminal to allow communication with the connected second terminal. The third communication interface is connectable to a network to allow communication with a device on the network. The controller controls the first communication interface, the second communication interface, and the third communication interface for communication. The controller communicates with the device on the network to collect data from the device and transmits the collected data to the first terminal, and transmits the collected data to the second terminal when the communication with the first terminal is disconnected.

### TECHNICAL FIELD

The present disclosure relates to an expansion board, a data collection system, a data collection method, and a program.

### BACKGROUND ART

An industrial network is used to allow devices including an input device, an output device, and a controller to cooperate with one another under a proprietary communication standard. To analyze data collected from the devices on the industrial network, a high-performance terminal, including a personal computer, is to be connected to the industrial network using an expansion board.

Patent Literature 1 describes an interface device including a Peripheral Component Interconnect Express (PCIe) interface, a Universal Serial Bus (USB) interface, and a system controller that controls the PCIe interface and the USB interface. The interface device can selectively switch the connection to the system controller between the PCIe interface and the USB interface.

### CITATION LIST

### Patent Literature

Patent Literature 1: Unexamined Japanese Patent Application Publication No. 2012-226457

### SUMMARY OF INVENTION

### Technical Problem

The device described in Patent Literature 1 can implement two communication interfaces in a personal computer with a single communication path and switch between the two communication interfaces. However, when the communication established with the personal computer is disconnected, the communication cannot continue through either communication interface.

In response to the above issue, an objective of the present disclosure is to provide an expansion board, a data collection system, a data collection method, and a program for maintaining connection between a terminal and an industrial network through connection redundancy.

### Solution to Problem

To achieve the above objective, an expansion board according to an aspect of the present disclosure includes a first communication interface, a second communication interface, a third communication interface, and a controller. The first communication interface is connectable to a first terminal to allow communication with the connected first terminal. The second communication interface is connectable to a second terminal to allow communication with the connected second terminal. The third communication interface is connectable to a network to allow communication with a device on the network. The controller controls the first communication interface, the second communication interface, and the third communication interface for communication. The controller communicates with the device on the network to collect data from the device and transmits the collected data to the first terminal, and transmits the collected data to the second terminal when the communication with the first terminal is disconnected.

### ADVANTAGEOUS EFFECTS OF INVENTION

The technique according to the above aspect of the present disclosure can provide an expansion board, a data collection system, a data collection method, and a program for maintaining connection between a terminal and an industrial network through connection redundancy.

### BRIEF DESCRIPTION OF DRAWINGS

FIG. 1 is a block diagram of a data collection system according to an embodiment;

FIG. 2 is a perspective view of an expansion board according to the embodiment;

FIG. 3 is a block diagram of the expansion board according to the embodiment;

FIG. 4 is a flowchart of an example of data collection performed by the expansion board according to the embodiment;

FIG. 5 is a flowchart of another example of data collection performed by the expansion board according to the embodiment; and

FIG. 6 is a block diagram of a data collection system according to a modification.

### DESCRIPTION OF EMBODIMENTS

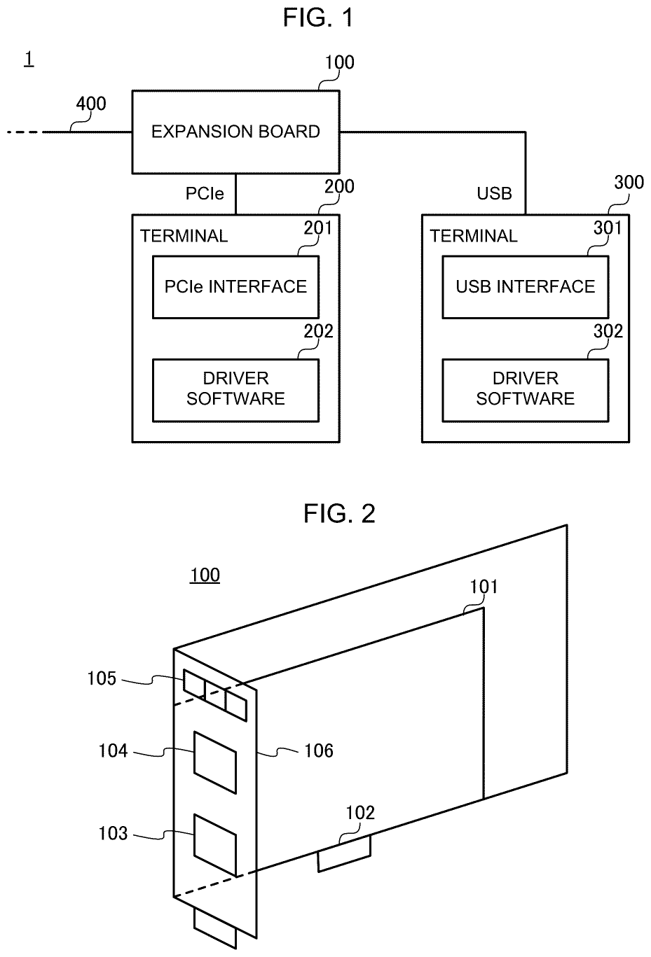

A data collection system 1 according to an embodiment of the present disclosure is described with reference to FIGS. 1 to 6. Like reference signs denote like or corresponding components in the drawings. The data collection system 1 according to the embodiment collects data from devices on an industrial network and stores the data redundantly into multiple terminals.

FIG. 1 is a block diagram of the data collection system 1 according to the embodiment. As illustrated in FIG. 1, the data collection system 1 includes an expansion board 100 connected to an industrial network 400 to collect data, a terminal 200 connected to the expansion board 100 with Component Interconnect Express (PCIe), and a terminal 300 connected to the expansion board 100 with a Universal Serial Bus (USB).

The expansion board 100 is a device connected to the industrial network 400 to collect data on the industrial network 400. The expansion board 100 is connected to the terminal 200 through a PCIe interface 201 included in the terminal 200. The expansion board 100 communicates with the terminal 200 through driver software 202 installed in the terminal 200. The expansion board 100 collects data by communicating with devices connected to the industrial network 400 based on communication settings set through the driver software 202 installed in the terminal 200.

The expansion board 100 is connected to the terminal 300 through a USB interface 301 included in the terminal 300. The expansion board 100 communicates with the terminal 300 through driver software 302 installed in the terminal 300.

The terminal 200 is a first terminal that receives and stores data collected by the expansion board 100. The terminal 200 includes the PCIe interface 201 connected to the expansion board 100 and has the driver software 202 installed for allowing the communication with the expansion board 100 and the setup of the communication settings on the expansion board 100. The terminal 200 may include a processor, a storage device, or an interface, although such components are not illustrated. The terminal 200 may be, but not limited to, a personal computer.

Similarly to the terminal 200, the terminal 300 is a second terminal that receives and stores data collected by the expansion board 100. The terminal 300 includes the USB interface 301 connected to the expansion board 100 and has the driver software 302 installed for allowing the communication with the expansion board 100 and the setup of the communication settings on the expansion board 100. The terminal 300 may include a processor, a storage device, or an interface, although such components are not illustrated. The terminal 300 may be, but not limited to, a personal computer.

FIG. 2 is a perspective view of the expansion board 100. As illustrated in FIG. 2, the expansion board 100 includes an electronic board 101 on which electronic components are placed, a bus interface 102 that is a terminal port connected to the terminal 200, a USB port 103 that is a port conforming to the USB standard, an industrial network port 104 that is a port conforming to the standard for the industrial network 400, a light-emitting diode (LED) 105 that lights up or blinks to visually inform the user, and a mount 106 that is a metal fitting fixable to a housing of the terminal 200.

The electronic board 101 is an electronic board on which a circuit, a processor, and a storage device are placed. The electronic board 101 is placed on the mount 106 and connected to the bus interface 102, the industrial network port 104, the USB port 103, the mount 106, and the LED 105.

The bus interface 102 is a connection terminal conforming to the PCIe standard and connectable to a PCIe slot. The bus interface 102 is connected to the PCIe interface 201 in the terminal 200.

The USB port 103 is a port conforming to the USB standard and connectable to a USB terminal. The USB port 103 is connected to the terminal 300 with a USB cable.

The industrial network port 104 is a port conforming to the standard for the industrial network 400 and connectable to a cable or an antenna included in the industrial network 400.

The LED 105 is a light emitter that can light up or blink. The LED 105 lights up or blinks to inform the user of an error detected in the connection of the expansion board 100 to the terminal 200 and the terminal 300.

The mount 106 is a member on which the electronic board 101, the bus interface 102, the USB port 103, the industrial network port 104, and the LED 105 are placed. The mount 106 is to be fixed to the housing of the terminal 200 with the bus interface 102 connected to the PCIe interface 201 in the terminal 200. In other words, the mount 106 is to be placed at a position corresponding to a PCIe expansion slot in the housing of the terminal 200. The mount 106 may be formed from a material including, but not limited to, metal or resin.

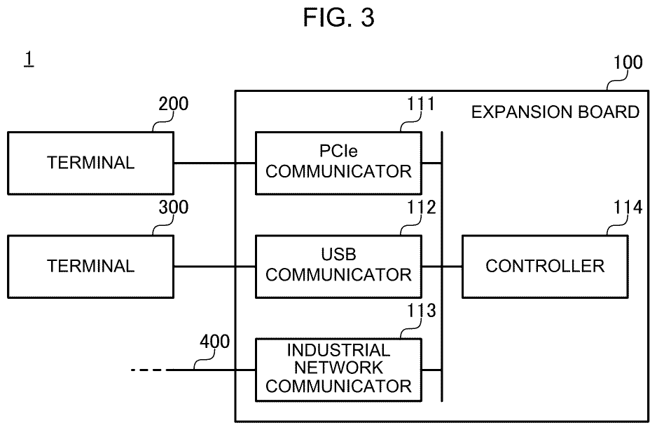

FIG. 3 is a block diagram of the expansion board 100. As illustrated in FIG. 3, the expansion board 100 includes a PCIe communicator 111 that controls PCIe communication with the terminal 200, a USB communicator 112 that controls USB communication with the terminal 300, an industrial network communicator 113 that controls communication with an industrial network, and a controller 114 that collects data and determines whether a communication error or a terminal error has occurred.

The PCIe communicator 111 is connected to a signal line of the bus interface 102 included in a PCIe bus to control PCIe bus communication. The PCIe communicator 111 recognizes the terminal 200 connected with the PCIe bus and controls communication with the terminal 200. At least one of the PCIe communicator 111 or the bus interface 102 corresponds to a first communication interface.

The USB communicator 112 is connected to a signal line of the USB port 103 included in the USB and controls USB communication. The USB communicator 112 recognizes the terminal 300 connected with the USB and controls communication with the terminal 300. At least one of the USB communicator 112 or the USB port 103 corresponds to a second communication interface.

The industrial network communicator 113 is connected to a signal line of the industrial network port 104 to control communication through the industrial network 400. The industrial network communicator 113 recognizes devices on the industrial network 400 and controls communication with the devices on the industrial network 400. At least one of the industrial network communicator 113 or the industrial network port 104 corresponds to a third communication interface.

The controller 114 controls the PCIe communicator 111, the USB communicator 112, and the industrial network 400 to communicate with the terminal 200, the terminal 300, and the devices on the industrial network 400. The controller 114 collects data through the industrial network 400 from the devices connected to the industrial network 400. The controller 114 monitors the communication status of the expansion board 100 with the terminal 200 and the terminal 300 and the operation statuses of the terminal 200 and the terminal 300 and notifies the user when detecting an error. The controller 114 may be, but not limited to, a circuit.

The controller 114 controls the industrial network communicator 113 to collect industrial network data through the industrial network, and transmits the collected data to and stores the data into the terminal 200 and the terminal 300.

The process performed by the controller 114 to collect data while monitoring the access through the PCIe bus is described. The controller 114 monitors the status of the communication with the terminal 200 through the PCIe bus. When the terminal 200 has an access to the expansion board 100 through the PCIe bus, the controller 114 transmits the collected industrial network data to and stores the data into the terminal 200 through the PCIe bus.

The controller 114 monitors the status of communication with the terminal 300 connected to the expansion board 100 with the USB and the operation status of the terminal 300. When detecting an error in the USB communication based on the monitoring of the USB communication status, the controller 114 reports the USB communication error to the terminal 200. When detecting an error in the operation of the terminal 300 based on the monitoring of the operation status of the terminal 300, the controller 114 reports the USB terminal operation error to the terminal 200.

When receiving a USB communication error or a USB terminal operation error from the expansion board 100, the driver software 202 installed in the terminal 200 notifies the user of the corresponding error in the USB communication or the operation of the terminal 300.

When the terminal 200 has no access to the expansion board 100 through the PCIe bus, the controller 114 queries the terminal 200 to determine whether the terminal 200 is accessible. When the terminal 200 is inaccessible, the controller 114 detects an error in the PCIe communication and reports the PCIe communication error to the terminal 300. When the terminal 200 is accessible, the controller 114 detects an error in the operation of the terminal 200 and reports the PCIe terminal operation error to the terminal 300. Errors in the operation of the terminal 200 may include, but are not limited to, a software error in the terminal 200.

When receiving a PCIe communication error or a PCIe terminal operation error from the expansion board 100, the driver software 302 installed in the terminal 300 notifies the user of the corresponding error in the PCIe communication or the operation of the terminal 200.

The process performed by the controller 114 to collect data while monitoring the access through the USB is described. The controller 114 monitors the status of the communication with the terminal 300 through the USB. When the terminal 300 has an access to the expansion board 100 through the USB, the controller 114 transmits the collected industrial network data to and stores the data into the terminal 300 through the USB.

The controller 114 monitors the status of communication with the terminal 200 connected to the expansion board 100 with the PCIe bus and the operation status of the terminal 200. When detecting an error in the PCIe communication based on the monitoring of the PCIe bus communication status, the controller 114 reports the PCIe communication error to the terminal 300. When detecting an error in the operation of the terminal 200 based on the monitoring of the operation status of the terminal 200, the controller 114 reports the PCIe terminal operation error to the terminal 300.

The PCIe communication monitoring and the error notification to the terminal 300 may include, but are not limited to, transmitting PCIe Advanced Error Reporting (AER) information to the terminal 300.

When receiving a PCIe communication error or a PCIe terminal operation error from the expansion board 100, the driver software 302 installed in the terminal 300 notifies the user of the corresponding error in the PCIe communication or the operation of the terminal 200.

When the terminal 300 has no access to the expansion board 100 through the USB, the controller 114 queries the terminal 300 to determine whether the terminal 300 is accessible. When the terminal 300 is inaccessible, the controller 114 detects an error in the USB communication and reports the USB communication error to the terminal 200. When the terminal 300 is accessible, the controller 114 detects an error in the operation of the terminal 300 and reports the USB terminal operation error to the terminal 200.

When receiving a USB communication error or a USB terminal operation error from the expansion board 100, the driver software 202 installed in the terminal 200 notifies the user of the corresponding error in the USB communication or the operation of the terminal 300.

The controller 114 monitors the PCIe communication and the USB communication in parallel. More specifically, an error detected in the PCIe communication or the PCIe-connected terminal 200 is reported to the USB-connected terminal 300, whereas an error detected in the USB communication or the USB-connected terminal 300 is reported to the PCIe-connected terminal 200.

In a failure in both the PCIe communication and the USB communication, or more specifically, when detecting at least one of a PCIe communication error or a PCIe terminal operation error and at least one of a USB communication error or a USB terminal operation error, the controller 114 controls the LED 105 to light up or blink, informing the user of the failure in both the PCIe communication and the USB communication.

When determining that the communication with the expansion board 100 is disconnected, the driver software 202 in the terminal 200 and the driver software 302 in the terminal 300 notify the user of the disconnection of the communication with the expansion board 100.

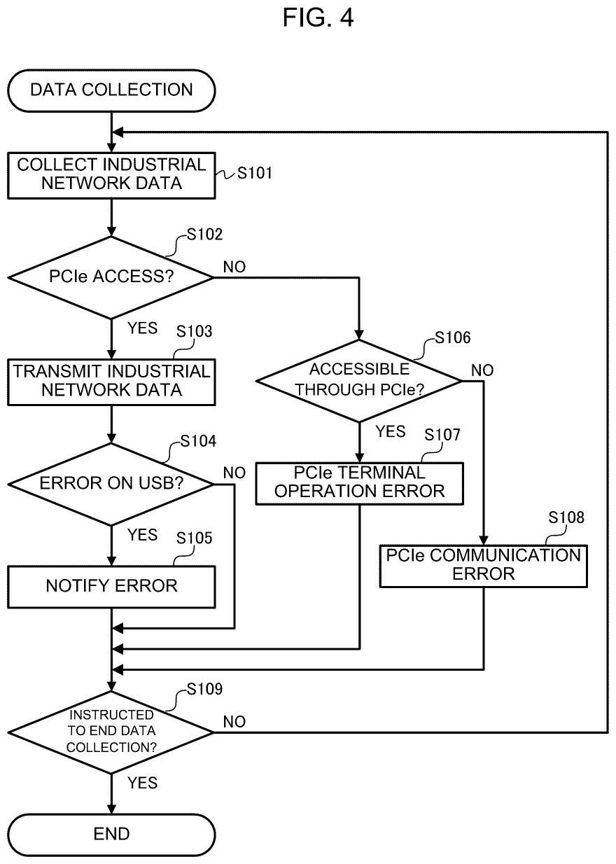

FIG. 4 is a flowchart of an example of data collection performed by the expansion board 100. The data collection is described with reference to the flowchart in FIG. 4.

When the data collection starts, the controller 114 in the expansion board 100 controls the industrial network communicator 113 to collect industrial network data (step S101).

When collecting the industrial network data, the controller 114 monitors the status of he communication with the terminal 200 through the PCIe bus to determine whether the terminal 200 has an access to the expansion board 100 through the PCIe bus (step S102).

When determining that the terminal 200 has an access to the expansion board 100 through the PCIe bus (Yes in step S102), the controller 114 transmits the collected industrial network data to the terminal 200 through the PCIe bus (step S103).

When transmitting the industrial network data, the controller 114 monitors the status of communication with the terminal 300 connected to the expansion board 100 with the USB and the operation status of the terminal 300 to determine whether a USB communication error or a USB terminal operation error is detected, or in other words, an error is detected on the USB (step S104). When detecting neither a USB communication error nor a USB terminal operation error (No in step S104), the controller 114 advances to step S109.

When detecting a USB communication error or a USB terminal operation error (Yes in step S104), the controller 114 notifies the terminal 200 of the USB communication error or the USB terminal operation error through the PCIe bus (step S105) and advances to step S109.

When determining that the terminal 200 has no access to the expansion board 100 through the PCIe bus (No in step S102), the controller 114 determines whether the terminal 200 is accessible through the PCIe bus (step S106).

When determining that the terminal 200 is accessible (Yes in step S106), the controller 114 detects an error in the operation of the terminal 200, determining that a PCIe terminal operation error has occurred (step S107).

When determining that the terminal 200 is inaccessible (No in step S106), the controller 114 detects an error in the PCIe communication, determining that a PCIe communication error has occurred (step S108).

When determining that a PCIe terminal operation error or a PCIe communication error has occurred, the controller 114 determines whether an instruction to end the data collection has been issued with the terminal 200 (step S109). When determining that no instruction to end the data collection has been issued (No in step S109), the controller 114 returns to step S101.

When determining that an instruction to end the data collection has been issued (Yes in step S109), the controller 114 ends the data collection.

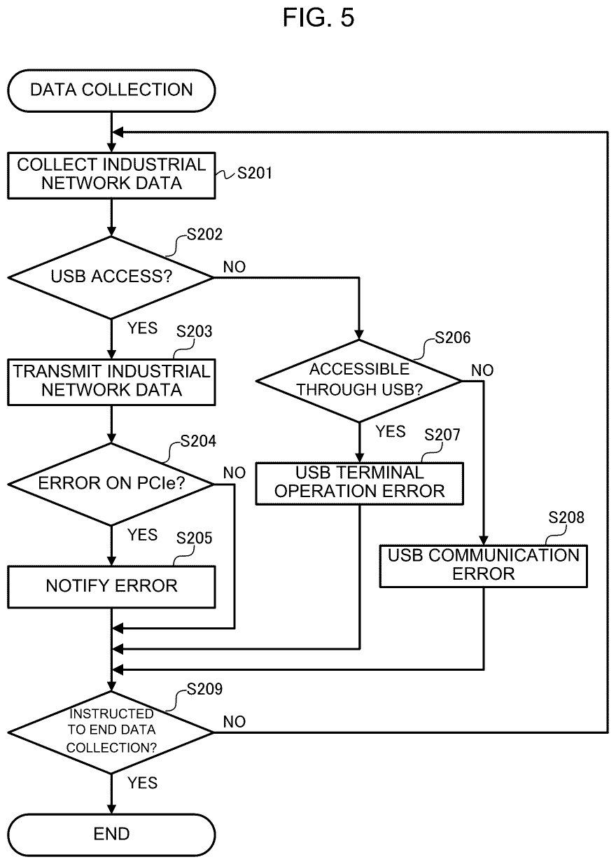

FIG. 5 is a flowchart of another example of data collection performed by the expansion board 100. The data collection is described with reference to the flowchart in FIG. 5.

When the data collection starts, the controller 114 in the expansion board 100 controls the industrial network communicator 113 to collect industrial network data (step S201).

When collecting the industrial network data, the controller 114 monitors the status of USB communication with the terminal 300 to determine whether the terminal 300 has an access to the expansion board 100 through the USB (step S202).

When determining that the terminal 300 has an access to the expansion board 100 through the USB (Yes in step S202), the controller 114 transmits the collected industrial network data to the terminal 300 through the USB (step S203).

When transmitting the industrial network data, the controller 114 monitors the status of communication with the terminal 200 connected to the expansion board 100 with PCIe and the operation status of the terminal 200 to determine whether a PCIe communication error or a PCIe terminal operation error is detected, or in other words, an error is detected on the PCIe (step S204). When detecting neither a PCIe communication error nor a PCIe terminal operation error (No in step S204), the controller 114 advances to step S209.

When detecting a PCIe communication error or a PCIe terminal operation error (Yes in step S204), the controller 114 notifies the terminal 300 of the PCIe communication error or the PCIe terminal operation error through the USB (step S205) and advances to step S209.

When determining that the terminal 300 has no access to the expansion board 100 through the USB (No in step S202), the controller 114 determines whether the terminal 300 is accessible through the USB (step S206).

When determining that the terminal 300 is accessible (Yes in step S206), the controller 114 detects an error in the operation of the terminal 300, determining that a USB terminal operation error has occurred (step S207).

When determining that the terminal 300 is inaccessible (No in step S206), the controller 114 detects an error in the USB communication, determining that a USB communication error has occurred (step S208).

When determining that a USB terminal operation error or a USB communication error has occurred, the controller 114 determines whether an instruction to end the data collection has been issued with the terminal 300 (step S209). When determining that no instruction to end the data collection has been issued (No in step S209), the controller 114 returns to step S201.

When determining that an instruction to end the data collection has been issued (Yes in step S209), the controller 114 ends the data collection.

The data collection system with the above configuration according to the embodiment includes the terminals connected with PCIe and an USB to the expansion board connected to the industrial network, and performs data collection while maintaining the connection between the terminals and the industrial network through connection redundancy.

When one of the PCIe communication or the USB communication is disconnected, the data collection system according to the embodiment notifies the terminal connected with the other interface of the disconnection, allowing the terminal to store data at the disconnection and reliably retain data useful for system integrity.

### Modification

Although the expansion board 100 described above is connected to the terminal 200 through the PCIe interface 201 included in the terminal 200, the connection is not limited to the above. The connection may be established with the terminal 200 under another standard, including Peripheral Component Interconnect (PCI), for communication.

Similarly, although the expansion board 100 described above is connected to the terminal 300 through the USB interface 301 included in the terminal 300, the connection is not limited to the above. The connection may be established with the terminal 200 based on another standard, including PCI, for communication or based on PCIe in the same manner as the terminal 200 for communication.

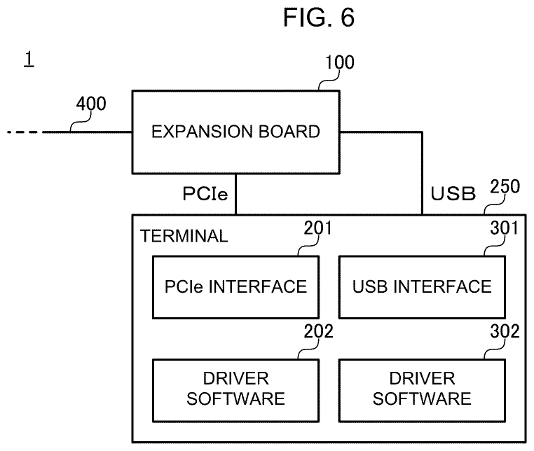

Although the expansion board 100 described above is connected to both the terminal 200 and the terminal 300, the connection is not limited to the above. The connection may be established with the terminal 200 alone. FIG. 6 is a block diagram of a data collection system 1 according to a modification. As illustrated in FIG. 6, the data collection system 1 includes an expansion board 100 and a terminal 250 connected with PCIe and an USB to the expansion board 100. The system can be downsized by reducing the terminals connected to the expansion board 100 to a single terminal.

Although the expansion board 100 described above communicates with the PCIe-connected terminal 200 and the USB-connected terminal 300 at the same time, the communication is not limited to the above. The expansion board 100 may communicate with the PCIe-connected terminal 200 alone. When a PCIe communication error or a PCIe terminal operation error is detected, the expansion board 100 may communicate with the terminal 200. The expansion board 100 may communicate with the USB-connected terminal 300 alone. When a USB communication error or a USB terminal operation error is detected, the expansion board 100 may communicate with the terminal 300. The communication limited to one of the terminal 200 or the terminal 300 can prevent the other terminal from consuming processing resources.

In the flowcharts in FIGS. 4 and 5, although the data collection described above ends when an instruction is issued to end the data collection, the data collection is not limited to the above. When detecting at least one of a PCIe communication error or a PCIe terminal operation error and at least one of a USB communication error or a USB terminal operation error, the data collection may end after the LED 105 is controlled to notify the user of the failure in both the PCIe communication and the USB communication.

Means and methods for implementing various processes in the data collection system according to the embodiment may also be implemented by a dedicated hardware circuit or a programmed computer. The computer may have a program through a non-transitory computer-readable recording medium, including a flexible disk or a compact disc read-only memory (CD-ROM), or online through a network, including the Internet. In this case, the program recorded in the non-transitory computer-readable recording medium is typically transferred to and stored into a storage device, including a hard disk drive. The program may be provided as a single application of software or incorporated in software for a device as a function of the device.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

One or more embodiments of the present disclosure are applicable to an expansion board, a data collection system, a data collection method, and a program.

### REFERENCE SIGNS LIST

1 Data collection system
100 Expansion board
101 Electronic board
102 Bus interface
103 USB port
104 Industrial network port
105 LED
106 Mount
111 PCIe communicator
112 USB communicator
113 Industrial network communicator
114 Controller
200, 250, 300 Terminal
201 PCIe interface
202, 302 Driver software
301 USB interface
400 Industrial network

1. An expansion board, comprising:
a first communication interface connectable to a first terminal to allow communication with the connected first terminal;
a second communication interface connectable to a second terminal to allow communication with the connected second terminal;
a third communication interface connectable to a network to allow communication with a device on the network; and
processing circuitry to control the first communication interface, the second communication interface, and the third communication interface for communication,
wherein the processing circuitry
communicates with the device on the network to collect data from the device and transmits the collected data to the first terminal,
when the communication with the first terminal is disconnected, notifies the second terminal of disconnection of the communication with the first terminal, transmits the collected data to the second terminal and stores the collected data into the second terminal, and
when the communication with the second terminal is disconnected, notifies the first terminal of disconnection of the communication with the second terminal, transmits the collected data to the first terminal, and stores the collected data into the first terminal.

2. (canceled)

3. The expansion board according to claim 1, wherein
the processing circuitry transmits the collected data to the second terminal when the communication with the first terminal remains connected.

4. The expansion board according to claim 1, wherein
the processing circuitry notifying the second terminal of disconnection of the communication with the first terminal includes
the processing circuitry querying the first terminal to determine whether the first terminal is accessible when the communication with the first terminal is disconnected,
the processing circuitry detecting, when the first terminal is inaccessible, an error in the communication through the first communication interface and reporting the error in the communication through the first communication interface to the second terminal, and
the processing circuitry detecting, when the first terminal is accessible, an error in operation of the first terminal and reporting the error in the operation of the first terminal to the second terminal.

5. The expansion board according to claim 1, wherein
the processing circuitry notifying the first terminal of disconnection of the communication with the second terminal includes
the processing circuitry querying the second terminal to determine whether the second terminal is accessible when the communication with the second terminal is disconnected,
the processing circuitry detecting, when the second terminal is inaccessible, an error in the communication through the second communication interface and reporting the error in the communication through the second communication interface to the first terminal, and
the processing circuitry detecting, when the second terminal is accessible, an error in operation of the second terminal and reporting the error in the operation of the second terminal to the first terminal.

6. The expansion board according to claim 1, wherein
a single terminal functions as the first terminal and the second terminal.

7. The expansion board according to claim 1, wherein
the second communication interface and the first communication interface conform to different standards.

8. A data collection system, comprising:
the expansion board according to claim 1;
the first terminal to communicate with the expansion board through the first communication interface; and
the second terminal to communicate with the expansion board through the second communication interface.

9. A data collection method, comprising:
communicating, through a third communication interface connectable to a network to allow communication with a device on the network, with the device on the network to collect data from the device;
transmitting the collected data to a first terminal through a first communication interface connectable to the first terminal to allow communication with the connected first terminal;
when the communication with the first terminal is disconnected, notifying a second terminal through a second communication interface connectable to the second terminal to allow communication with the connected second terminal, transmitting the collected data to the second terminal through the second communication interface, and stores the collected data into the second terminal; and
when the communication with the second terminal is disconnected, notifying the first terminal of disconnection of the communication with the second terminal, transmitting the collected data to the first terminal, and storing the collected data into the first terminal.

10. A non-transitory computer-readable recording medium storing a program, the program causing a computer to perform operations comprising:
communicating, through a third communication interface connectable to a network to allow communication with a device on the network, with the device on the network to collect data from the device;
transmitting the collected data to a first terminal through a first communication interface connectable to the first terminal to allow communication with the connected first terminal;
when the communication with the first terminal is disconnected, notifying a second terminal through a second communication interface connectable to the second terminal to allow communication with the connected second terminal, transmitting the collected data to the second terminal through the second communication interface, and stores the collected data into the second terminal; and
when the communication with the second terminal is disconnected, notifying the first terminal of disconnection of the communication with the second terminal, transmitting the collected data to the first terminal, and storing the collected data into the first terminal.
